(19) United States
(12) Patent Application Publication
(10) Pub. No.: US 2010/0094670 A1
(43) Pub. Date: Apr. 15, 2010

(54) Interfacing A Building Contractor And A User

(76) Inventor: Shlomi Talmor, Moshav Bnei-Dror (IL)

Correspondence Address: The Law Office of Michael E. Kondoudis, 888 16th Street, N.W., Suite 800, Washington, DC, 20006, US

(21) Appl. No.: 12/249,979

(22) Filed: Oct. 13, 2008

(51) Int. Cl. G06F 19/00; G06F 17/00

(52) U.S. Cl. 705/7; 700/83; 705/400

(57) ABSTRACT

A data processing system for and a computer implemented method of providing an interface between a contractor of a building including units and a user related to some units. The data processing system includes an interface server connected to the contractor and to the user and including a graphical user interface, an analyzing module and a physical rules implementation module. The system receives construction plans, converts them to system objects, determines the associations among the system objects, applies physical rules to the system objects, allows the user to define changes to the system objects, calculates effects of the user defined changes on other system objects in the unit, verifies their feasibility and provides the changes in the plans to the contractor.

### FIELD OF THE INVENTION

The present invention generally relates to the field of managing systems. More particularly, the present invention relates to an interface managing system connecting users and building contractors.

### BACKGROUND OF THE INVENTION

Construction process is a very complex process, managed by contractors and involving clients that commonly want to influence the construction process, yet lack the professional skills to do so. Contractors on the other hand often find it difficult to comply with client requests within the scope of their technical responsibility, and especially within physical limitations and time limitations imposed but such a complex process.

### BRIEF SUMMARY

The present invention includes a data processing system for and a computer implemented method of providing an interface between a contractor of a building and a user. The building comprises at least one unit and the user is related to at least one of the units in the building. One data processing system comprises an interface server connected to the contractor and to the user. One interface server comprises a graphical user interface, an analyzing module and a physical rules implementation module. The graphical user interface is arranged to receive a plurality of plans, related to the construction of the at least one unit and to the construction of the building, from the contractor. The analyzing module is arranged to convert the contractor plans to a plurality of system objects. The system objects are related to the structure of the at least one unit and to the structure of the building, and the analyzing module is further arranged to determine the associations among the system objects. The physical rules implementation module is arranged to apply physical rules to the plurality of system objects. The physical rules relate to rules of integrating the plurality of system objects, rules of interrelating the plurality of system objects with the structure of the building and rules of constructing the building. The graphical user interface is further arranged to allow the user to define changes to the plurality of system objects, wherein the defined changes to the plurality of system objects are related to changes in the structure of at least one of the at least one unit. The analyzing module is further arranged to calculate effects of the user defined changes on other system objects in the at least one of the at least one unit. The physical rules implementation module is further arranged to verify the feasibility of the user defined changes. The graphical user interface is further arranged to provide changes in the plans to the contractor.

One computer implemented method comprises the stages: (i) receiving a plurality of plans from the contractor, wherein the plurality of plans relate to the construction of the at least one unit and to the construction of the building; (ii) converting the plurality of contractor plans to a plurality of system objects, wherein the plurality of system objects are related to the structure of the at least one unit and to the structure of the building; (iii) determining the associations among the plurality of system objects; (iv) applying physical rules to the plurality of system objects, wherein the physical rules relate to rules of integrating the plurality of system objects, rules of interrelating the plurality of system objects with the structure of the building and rules of constructing the building; (v) allowing the user to define changes to the plurality of system objects, wherein the defined changes to the plurality of system objects are related to changes in the structure of at least one of the at least one unit; (vi) calculating effects of the user defined changes on other system objects in the at least one of the at least one unit; (vii) verifying feasibility of the user defined changes; and (viii) providing changes in the plurality of plans to the contractor.

One data processing system comprises a client terminal and a mediator server. The client terminal is operable by the user and comprises a graphical user interface. The mediator server is connected via a first communication link to the contractor and connected via a second communication link to the client terminal. The mediator server comprises an interface module, an analyzing module, and a physical rules implementation module. The interface module is arranged to receive a plurality of plans, relating to the construction of the at least one unit and to the construction of the building, from the contractor. The analyzing module is arranged to convert the contractor plans to a plurality of system objects. The physical rules implementation module is arranged to apply physical rules to the plurality of system objects. The interface module is arranged to provide the plurality of system objects to the graphical user interface. The graphical user interface is further arranged to allow the user to define changes to the plurality of system objects. The defined changes to the plurality of system objects are related to changes in the structure of at least one of the at least one unit. The graphical user interface is further arranged to provide the user defined changes to the plurality of system objects to the interface module. The analyzing module is further arranged to calculate effects of the user defined changes on other system objects in the at least one of the at least one unit. The physical rules implementation module is further arranged to verify the feasibility of the user defined changes. Finally, the interface module is further arranged to provide changes in the plans to the contractor.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings (Figures, or simply “FIGS.”), wherein:

FIG. 1 is a flowchart of a computer implemented method of providing an interface between a contractor of a building and a user, according to some embodiments of the invention;

FIG. 2 is a block diagram illustrating a data processing system for providing an interface between a contractor of a building and a user, according to some embodiments of the invention;

FIGS. 3A, 3B, 3C are flowcharts of a computer implemented method of providing an interface between a contractor and a user, according to some embodiments of the invention; and

FIG. 4 is a block diagram illustrating a data processing system for providing an interface between a contractor of a building and a user, according to some embodiments of the invention.

### DETAILED DESCRIPTIONS OF SOME EMBODIMENTS OF THE INVENTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. In other instances, well-known methods, procedures, components and circuits have not been described in detail so as not to obscure the teachings of the present disclosure.

For a better understanding of the invention, the usages of the following terms in the present disclosure are defined in a non-limiting manner.

The term “unit” (building unit) as used herein in this application, is defined as any part of a building such as apartments, shops, rooms, working spaces, storerooms, parking places and so forth.

The term “change” (user changes to unit or building plans) as used herein in this application, is defined as any addition, modification or removal of elements relating to the unit or the building.

The term “plan” (contractor plan, building plans) as used herein in this application, is defined as all construction related schemes, programs, schedules, drawings or diagrams, including the time tables and Gantt charts for the building and for individual units.

The term “planning layer” as used herein in this application, is defined as a thematic component (or sub-plan) of the contractor's plan such as construction, plumbing, electricity, air conditioning, surfacing and covering, furniture and so forth.

The term “system object” as used herein in this application, is defined as any element relating to the building, its unit and their construction, as represented in the system described below. System objects may comprise walls of any type such as doors, windows, pipes, baths, toilets, sinks, kitchen parts, furniture as well as fixed points (plumbing and electricity points, structural walls, etc.). System objects may be characterized by parameters such as: Physical dimensions, location data, relation (temporal, spatial, functional) to other system objects, relation (temporal, spatial, functional) to construction stages.

The term “physical rules” (physical conditions) as used herein in this application, is defined as the interdependencies governing allowable constellations of system objects within the framework of construction plans. For examples, interdependencies among structural elements, between structural elements and plumbing elements, physical limitations relating to dimensions including weight, municipal limitations, contradiction between system objects and so forth. The physical rules include rules of integrating the system objects, rules of interrelating the system objects with the structure of the building and rules of constructing the building.

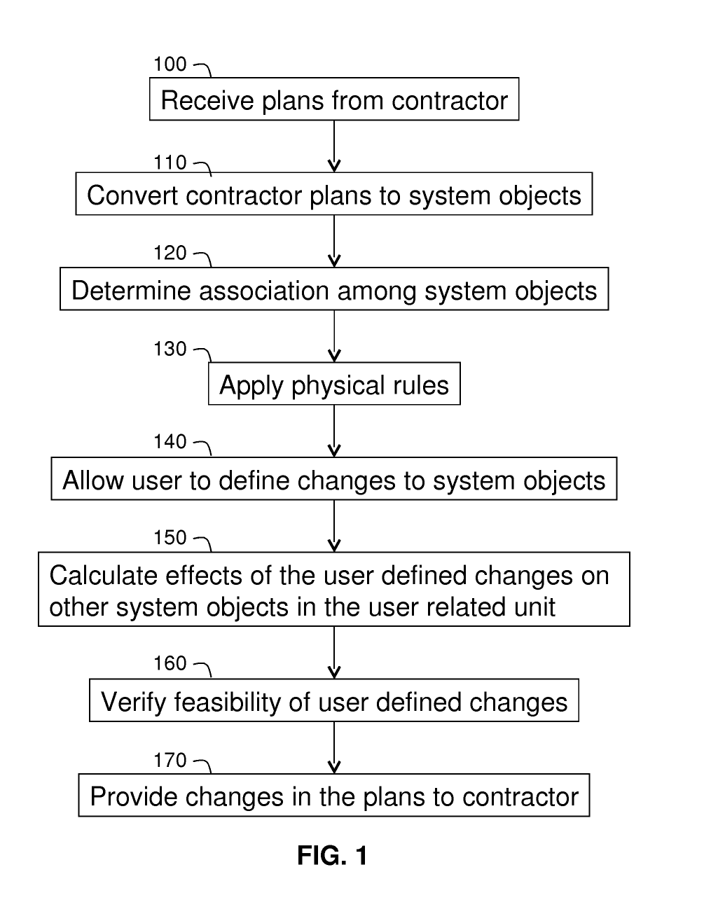

FIG. 1 is a flowchart of a computer implemented method of providing an interface between a contractor of a building and a user, according to some embodiments of the invention. The building comprises units and the user is related to at least one of the units in the building. The illustrated computer implemented method comprises the following stages:
Receiving plans from the contractor (stage 100). The plans relate to the construction of the units and to the construction of the building;
Converting the contractor plans to system objects (stage 110). The system objects are related to the structure of the units and to the structure of the building;
Determining the associations among system objects (stage 120);
Applying physical rules to the system objects (stage 130). The physical rules relate to rules of integrating the system objects, rules of interrelating the system objects with the structure of the building and rules of constructing the building;
Allowing the user to define changes to the system objects (stage 140). The defined changes to the system objects are related to changes in the structure of at least one of the units;
Calculating effects of the user defined changes on other system objects in the user related unit (the at least one of the at least one unit) (stage 150);
Verifying feasibility of the user defined changes (stage 160); and
Providing changes in the plans to the contractor (stage 170).

According to some embodiments of the invention, providing changes in the plans to the contractor (stage 170) may be carried out as either an amended plan, amended planning layers or as a list of changes together with a quantities list.

According to some embodiments of the invention, the computer implemented method may further comprise at least one of the stages: (i) Calculating the influence of the changes in relation to the dependencies among units of the building, (ii) calculating the influence of the changes on the time tables in the plurality of plans of the contractor, (iii) calculating the influence of the changes on the costs. The influence of the changes on the costs relates to and may be derived from the physical rules (e.g. moving a structural element may imply moving other elements, electricity or plumbing points etc.).

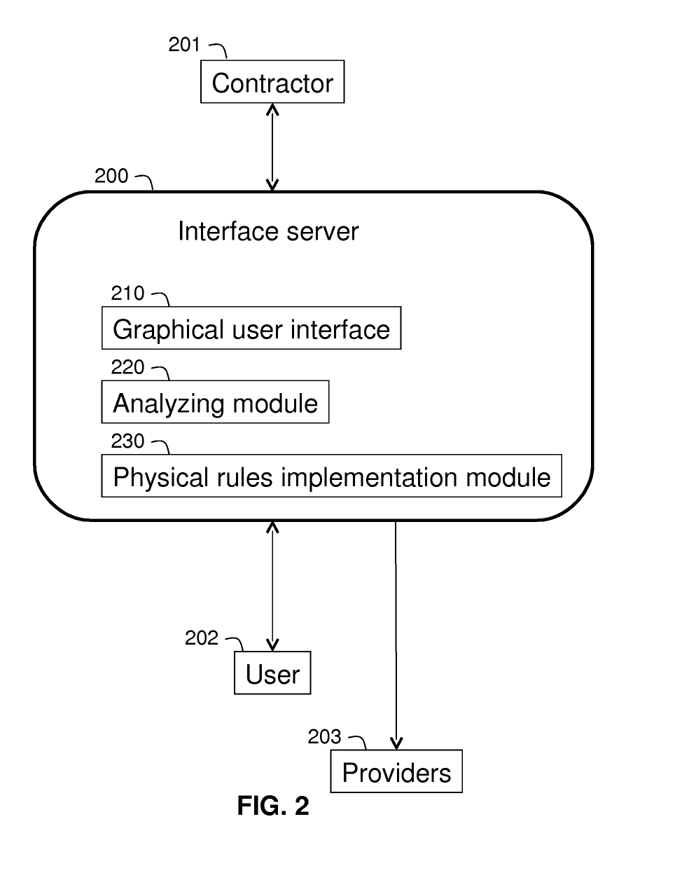

FIG. 2 is a block diagram illustrating a data processing system for providing an interface between a contractor 201 of a building and a user 202, according to some embodiments of the invention. The building comprises units and user 202 is related to at least one of the units in the building. The data processing system comprises an interface server 200 connected to contractor 201 and to user 202. Interface server 200 comprises a graphical user interface 210, an analyzing module 220 and a physical rules implementation module 230. Graphical user interface 210 is arranged to receive plans relating to the construction of the units and to the construction of the building from contractor 201. Analyzing module 220 is arranged to convert the plans to system objects that are related to the structure of the units and to the structure of the building. Analyzing module 220 is further arranged to determine the associations among the system objects. Physical rules implementation module 230 is arranged to apply physical rules to the system objects. The physical rules relate to rules of integrating the system objects, rules of interrelating the system objects with the structure of the building and rules of constructing the building. Graphical user interface 210 is further arranged to allow user 202 to define changes to the system objects, relating to changes in the structure of the units. Analyzing module 220 is further arranged to calculate effects of the user defined changes on other system objects in the user related unit. Physical rules implementation module 230 is further arranged to verify the feasibility of user defined changes, and graphical user interface 210 is finally arranged to provide changes in the plans to contractor 201. Providing the changes in the plans to contractor 201 may be carried out as either an amended plan, amended planning layers or as a list of changes together with a quantities list.

According to some embodiments of the invention, analyzing module 220 is further arranged to calculate the influence of the changes in relation to the dependencies among units of the building. According to some embodiments of the invention, analyzing module 220 is further arranged calculate the influence of the changes on the costs. The influence of the changes on the costs relates to and may be derived from the physical rules (e.g. moving a structural element may imply moving other elements, electricity or plumbing points etc.). According to some embodiments of the invention, analyzing module 220 is further arranged to calculate the influence of the changes on the time tables and Gantt charts in the plans of the contractor.

According to some embodiments of the invention, the computer implemented method and the data processing system allow an efficient transfer of information during the whole construction process between user 202 and contractor 201. Information may comprise queries, requests, messages and confirmations relating to any aspect of planning the building. The computer implemented method and the data processing system operate in relation to the graphical representation of the construction plans, thus keeping a common language among all participants. They are characterized by a permission system, allowing user 202 to change plans on the user's interface, yet acceptance of the changes may occur only by contractor 201 after a full check of all influences of user changes on the construction process, time tables, and all plan layers and units affected. In addition, all changes are directly linked to the contractor's price list, and all along the process, costs are presented and may be taken into account by both user 202 and contractor 201 on a common basis.

According to some embodiments of the invention, graphical user interface 210 may be enhanced by some or all of the following features:
A simulation of the lighting systems in the unit and of the illumination by the operation of different lighting elements;
A simulation of furniture according to user preferences in any configuration of the unit.

Either furniture or unit elements may be presented full or partly transparent to visualize their interacting effects;
A multiplicity of views, in 2D and 3D of the unit and its construction elements.
An integration of current state of the unit as construction progresses and simulation of the state of the unit in future dates, according to the planned timetables;
Interchangeable planning layers, denoted by different colors;
Advisory programs and links relating to matters of construction, design, finances and so forth; and
Designated tool boxes relating to planning layers. Each tool box may offer user 202 system objects and possible actions relating to each planning layer.

According to some embodiments of the invention, the computer implemented method and the data processing system create a quantities list to contractor 201, and send the quantities list to further providers 203. The computer implemented method and the data processing system may further connect user 202 to catalogues of providers 203, allow providers 203 to offer user 202 different offers, including their presentation utilizing graphical user interface 210 and in relation to the progress of construction and user changes. For example, offering a refrigerator by a provider may prompt graphical user interface 210 to suggest changing the plan for the kitchen to accommodate the refrigerator in all its layers (construction, plumbing, electricity etc.). The computer implemented method and the data processing system may suggest the necessary timing for decisions relating to purchases from providers 203 in relation to the progress of construction and final dates for related changes.

According to some embodiments of the invention, the computer implemented method and the data processing system may further manage the client files at contractor side.

According to some embodiments of the invention, the computer implemented method and the data processing system may be accessed from the web by non-users in relation to fictional buildings, units and plans or in relation to plans entered by the non-users, for demonstration purposes.

According to some embodiments of the invention, the computer implemented method and the data processing system may utilize FLASH technology.

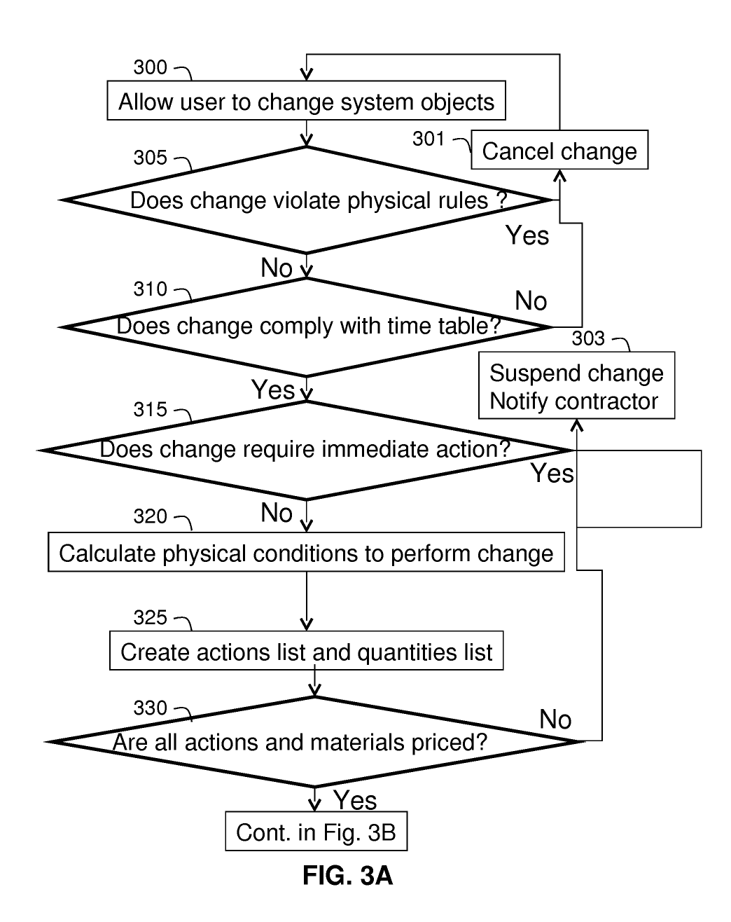

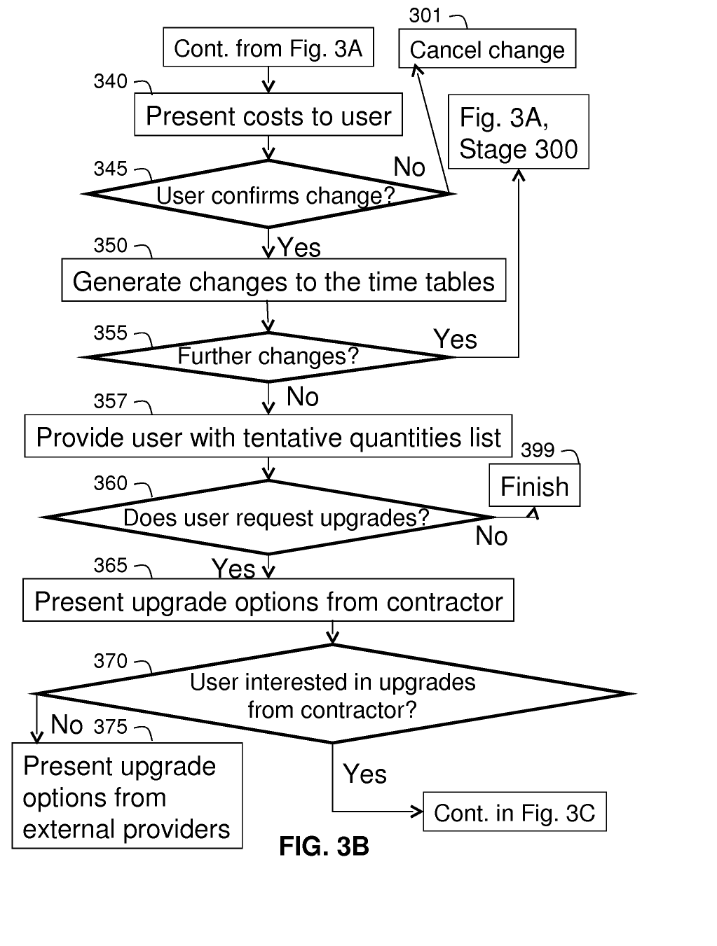

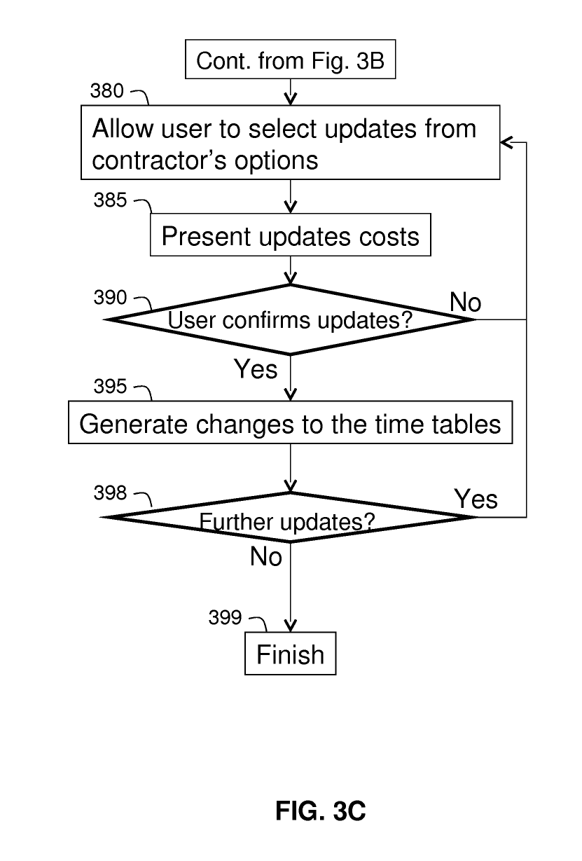

FIGS. 3A, 3B, 3C are detailed flowcharts of a computer implemented method of providing an interface between a contractor and a user, according to some embodiments of the invention. The illustrated computer implemented method comprises the following stages:
Allowing the user to change system objects (stage 300);
Checking the following conditions regarding user changes: Does change violate physical rules? (stage 305) If so—cancelling the change (stage 301) if not, checking: Does change comply with time table? (stage 310) If not—Cancelling the change (stage 301), if it does, checking: Does change require immediate action? (stage 315) If so—suspending the change and notifying the contractor (stage 303). If not—the method continues;
Calculating physical conditions to perform change (stage 320);
Creating actions list and quantities list (stage 325);
Checking—Are all actions and materials priced? (stage 330) If not—suspending the change and notifying the contractor (stage 303), if does—continuing (FIG. 3B);
Presenting costs to user (stage 340);
Checking: Does user confirm change? (stage 345) If not—Cancelling the change (stage 301);
Generating changes to the time tables (stage 350);
If further changes (stage 355) are defined by the user, stages 300-355 are repeated;
Providing the user with tentative quantities list (stage 357);
Checking: Does user request upgrades? (stage 360) If not finishing (stage 399) otherwise continuing;
Presenting upgrade options from contractor (stage 365);
Checking whether the user is interested in upgrades from the contractor? (stage 370) If not—presenting upgrade options from external providers (stage 375). If user does—continuing (FIG. 3C);
Allowing the user to select updates from the contractor's options (stage 380).
Presenting updates costs (stage 385); and
Checking: Does user confirm updates? (stage 380) If not—allowing user to select other updates (stage 380) otherwise checking whether the user wishes to select further updates (stage 398). If user does—repeating stage 380, otherwise finishing (stage 399).

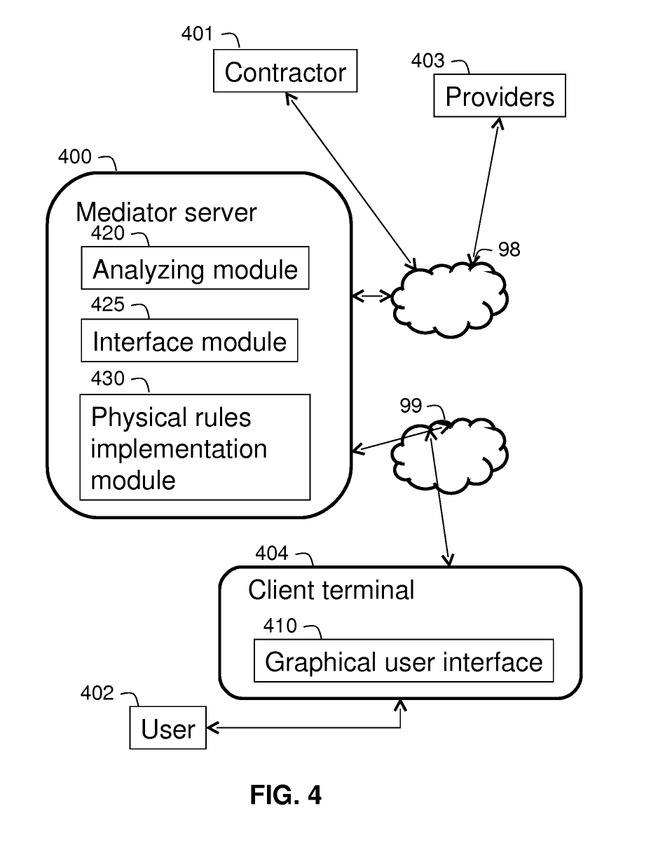

FIG. 4 is a block diagram illustrating a data processing system for providing an interface between a contractor of a building and a user, according to some embodiments of the invention. The building comprises units and user 202 is related to at least one of the units in the building. The data processing system comprises a client terminal 404 that is operable by the user and comprises a graphical user interface 410; and a mediator server 400 connected via a first communication link 98 to contractor 401 and connected via a second communication link 99 to client terminal 404. Mediator server 400 comprises an interface module 425, an analyzing module 420 and a physical rules implementation module 430. Interface module 425 is arranged to receive plans relating to the construction of the units and to the construction of the building from contractor 401. Analyzing module 420 is arranged to convert contractor plans to system objects relating to the structure of the units and to the structure of the building. Analyzing module 420 is further arranged to determine the associations among the system objects. Physical rules implementation module 430 is arranged to apply physical rules to the system objects, wherein the physical rules relate to rules of integrating the system objects, rules of interrelating the system objects with the structure of the building and rules of constructing the building. Interface module 425 is arranged to provide the system objects to graphical user interface 410, which is further arranged to allow user 402 to define changes related to changes in the structure of at least one of the units to the system objects. Graphical user interface 410 is further arranged to provide the user defined changes to the system objects to interface module 425. Analyzing module 420 is further arranged to calculate effects of the user defined changes on other system objects in the user related unit and physical rules implementation module 430 is further arranged to verify the feasibility of the user defined changes. Interface module is arranged to provide changes in the plans to contractor 401.

According to some embodiments of the invention, analyzing module 420 is further arranged to calculate the influence of the changes in relation to the dependencies among units of the building. According to some embodiments of the invention, analyzing module 420 is further arranged to calculate the influence of the changes on the costs. According to some embodiments of the invention, analyzing module is further arranged to calculate the influence of the changes on the time tables and Gantt charts in the plans of the contractor.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. A data processing system for providing an interface between a contractor of a building and a user, wherein the building comprises at least one unit and the user is related to at least one of the units in the building, the data processing system comprising an interface server connected to the contractor and to the user, the interface server comprising:
a graphical user interface arranged to receive a plurality of plans from the contractor, wherein the plurality of plans relate to the construction of the at least one unit and to the construction of the building;
an analyzing module arranged to convert the contractor plans to a plurality of system objects, wherein the plurality of system objects are related to the structure of the at least one unit and to the structure of the building, and wherein the analyzing module is further arranged to determine the associations among the system objects; and
a physical rules implementation module arranged to apply physical rules to the plurality of system objects, wherein the physical rules relate to rules of integrating the plurality of system objects, rules of interrelating the plurality of system objects with the structure of the building and rules of constructing the building;
wherein the graphical user interface is further arranged to allow the user to define changes to the plurality of system objects, wherein the defined changes to the plurality of system objects are related to changes in the structure of at least one of the at least one unit;
wherein the analyzing module is further arranged to calculate effects of the user defined changes on other system objects in the at least one of the at least one unit;
wherein the physical rules implementation module is further arranged to verify the feasibility of the user defined changes; and
wherein the graphical user interface is further arranged to provide changes in the plans to the contractor.

2. The data processing system of claim 1, wherein the analyzing module is further arranged to calculate the influence of the changes in relation to the dependencies among units of the building.

3. The data processing system of claim 1, wherein the plurality of plans comprises planning layers.

4. The data processing system of claim 1, wherein the analyzing module is further arranged to calculate the influence of the changes on the time tables in the plurality of plans of the contractor.

5. The data processing system of claim 1, wherein the analyzing module is further arranged to calculate the influence of the changes on the costs.

6. The data processing system of claim 5, wherein the influence of the changes on the costs is at least partly derived from at least one of the physical rules.

7. A computer implemented method of providing an interface between a contractor of a building and a user, wherein the building comprises at least one unit and the user is related to at least one of the units in the building, the computer implemented method comprising:
receiving a plurality of plans from the contractor, wherein the plurality of plans relate to the construction of the at least one unit and to the construction of the building;
converting the plurality of contractor plans to a plurality of system objects, wherein the plurality of system objects are related to the structure of the at least one unit and to the structure of the building;
determining the associations among the plurality of system objects;
applying physical rules to the plurality of system objects, wherein the physical rules relate to rules of integrating the plurality of system objects, rules of interrelating the plurality of system objects with the structure of the building and rules of constructing the building;
allowing the user to define changes to the plurality of system objects, wherein the defined changes to the plurality of system objects are related to changes in the structure of at least one of the at least one unit;
calculating effects of the user defined changes on other system objects in the at least one of the at least one unit; and
verifying feasibility of the user defined changes.

8. The computer implemented method of claim 7, further comprising calculating the influence of the changes in relation to the dependencies among units of the building.

9. The computer implemented method of claim 7, wherein the plurality of plans comprises planning layers.

10. The computer implemented method of claim 7, further comprising calculating the influence of the changes on the time tables in the plurality of plans of the contractor.

11. The computer implemented method of claim 7, further comprising calculating the influence of the changes on the costs.

12. The computer implemented method of claim 11, wherein the influence of the changes on the costs is at least partly derived from at least one of the physical rules.

13. A data processing system for providing an interface between a contractor of a building and a user, wherein the building comprises at least one unit and the user is related to at least one of the units in the building, the data processing system comprising:
a client terminal operable by the user comprising a graphical user interface; and
a mediator server connected via a first communication link to the contractor and connected via a second communication link to the client terminal, the mediator server comprising:
an interface module arranged to receive a plurality of plans from the contractor, wherein the plurality of plans relate to the construction of the at least one unit and to the construction of the building;
an analyzing module arranged to convert the contractor plans to a plurality of system objects, wherein the plurality of system objects are related to the structure of the at least one unit and to the structure of the building, and wherein the analyzing module is further arranged to determine the associations among the system objects; and
a physical rules implementation module arranged to apply physical rules to the plurality of system objects, wherein the physical rules relate to rules of integrating the plurality of system objects, rules of interrelating the plurality of system objects with the structure of the building and rules of constructing the building;
wherein the interface module is arranged to provide the plurality of system objects to the graphical user interface
wherein the graphical user interface is further arranged to allow the user to define changes to the plurality of system objects, wherein the defined changes to the plurality of system objects are related to changes in the structure of at least one of the at least one unit;
wherein the graphical user interface is further arranged to provide the user defined changes to the plurality of system objects to the interface module;
wherein the analyzing module is further arranged to calculate effects of the user defined changes on other system objects in the at least one of the at least one unit;
wherein the physical rules implementation module is further arranged to verify the feasibility of the user defined changes; and
wherein the interface module is further arranged to provide changes in the plans to the contractor.

14. The data processing system of claim 13, wherein the analyzing module is further arranged to calculate the influence of the changes in relation to the dependencies among units of the building.

15. The data processing system of claim 13, wherein the plurality of plans comprises planning layers.

16. The data processing system of claim 13, wherein the analyzing module is further arranged to calculate the influence of the changes on the time tables in the plurality of plans of the contractor.

17. The data processing system of claim 13, wherein the analyzing module is further arranged to calculate the influence of the changes on the costs.

18. The computer implemented method of claim 17, wherein the influence of the changes on the costs is at least partly derived from at least one of the physical rules.
